(19) United States
(12) Patent Application Publication
(10) Pub. No.: US 2020/0217125 A1
(43) Pub. Date: Jul. 9, 2020

(54) INTERNAL TUBE FOR VACUUM INSULATED GLASS (VIG) UNIT EVACUATION AND HERMETIC SEALING, VIG UNIT INCLUDING INTERNAL TUBE, AND ASSOCIATED METHODS

(71) Applicant: Guardian Glass, LLC, Auburn Hills, MI (US)

(72) Inventor: John P. HOGAN, Auburn Hills, MI (US)

(21) Appl. No.: 16/239,850

(22) Filed: Jan. 4, 2019

(51) Int. Cl. E06B 3/66; E06B 3/663; E06B 3/677

(52) U.S. Cl. CPC E06B 3/6612; E06B 3/6775; E06B 3/66304

(57) ABSTRACT

Certain example embodiments of this invention relate to vacuum insulated glass (VIG) units, and/or methods of making the same. The sealing tube or sealing material is provided within the VIG unit, thereby potentially eliminating the need for a protective cap and allowing for more freedom in handling, frame design, hybrid VIG construction, lamination, and the like. The sealing tube may be relocated to an internal area within a recessed pocket of a substrate at least in certain example embodiments. The VIG unit lacks a protruding pump-out tube or the like.

### TECHNICAL FIELD

Certain example embodiments of this invention relate to vacuum insulated glass (VIG) units, and/or methods of making the same. More particularly, certain example embodiments of this invention relate to an internal pump-out tube for VIG unit evacuation and hermetic sealing, a VIG unit subassembly including an internal pump-out tube, a VIG unit made using an internal pump-out tube, and/or associated methods.

### BACKGROUND AND SUMMARY

Vacuum insulating glass (VIG) units typically include at least two spaced apart glass substrates that enclose an evacuated or low-pressure space/cavity therebetween. The substrates are interconnected by a peripheral edge seal and typically include spacers between the glass substrates to maintain spacing between the glass substrates and to avoid collapse of the glass substrates that may be caused due to the low pressure environment that exists between the substrates. Some example VIG configurations are disclosed, for example, in U.S. Pat. Nos. 5,657,607, 5,664,395, 5,902,652, 6,506,472 and 6,383,580 the disclosures of which are all hereby incorporated by reference herein in their entireties.

FIGS. 1-2 illustrate a typical VIG unit 1 and elements that form the VIG unit 1. For example, VIG unit 1 may include two spaced apart substantially parallel glass substrates 2, 3, which enclose an evacuated low-pressure space/cavity 6 therebetween. Glass sheets or substrates 2,3 are interconnected by a peripheral edge seal 4 which may be made of fused solder glass, for example. An array of support pillars/spacers 5 may be included between the glass substrates 2, 3 to maintain the spacing of substrates 2, 3 of the VIG unit 1 in view of the low-pressure space/gap 6 present between the substrates 2, 3.

A pump-out tube 8 may be hermetically sealed by, for example, solder glass 9 to an aperture/hole 10 that passes from an interior surface of one of the glass substrates 2 to the bottom of an optional recess 11 in the exterior surface of the glass substrate 2, or optionally to the exterior surface of the glass substrate 2. A vacuum is attached to pump-out tube 8 to evacuate the interior cavity 6 to a low pressure, for example, using a sequential pump down operation. After evacuation of the cavity 6, a portion (e.g., the tip) of the tube 8 is melted to seal the vacuum in low pressure cavity/space 6. The optional recess 11 may retain the sealed pump-out tube 8. Optionally, a chemical getter 12 may be included within a recess 13 that is disposed in an interior face of one of the glass substrates, e.g., glass substrate 2. The chemical getter 12 may be used to absorb or bind with certain residual impurities that may remain after the cavity 6 is evacuated and sealed.

VIG units with fused solder glass peripheral edge seals 4 are typically manufactured by depositing glass frit, in a solution (e.g., frit paste), around the periphery of substrate 2 (or on substrate 3). This glass frit paste ultimately forms the glass solder edge seal 4. The other substrate (e.g., 3) is brought down on substrate 2 so as to sandwich spacers/pillars 5 and the glass frit solution between the two substrates 2, 3. The entire assembly including the glass substrates 2, 3, the spacers/pillars 5 and the seal material (e.g., glass frit in solution or paste), is then heated to a temperature of at least about 500 degrees C., at which point the glass frit melts, wets the surfaces of the glass substrates 2, 3, and ultimately forms a hermetic peripheral/edge seal 4.

After formation of the edge seal 4 between the substrates, a vacuum is drawn via the pump-out tube 8 to form low pressure space/cavity 6 between the substrates 2, 3. The pressure in space 6 may be produced by way of an evacuation process to a level below atmospheric pressure, e.g., below about 10⁻² Torr. To maintain the low pressure in the space/cavity 6, substrates 2, 3 are hermetically sealed. Small, high strength spacers/pillars 5 are provided between the substrates to maintain separation of the approximately parallel substrates against atmospheric pressure. As noted above, once the space 6 between substrates 2, 3 is evacuated, the pump-out tube 8 may be sealed, for example, by melting its tip using a laser or the like.

A typical process for installing the pump-out tube 8 in the hole or aperture 10 includes inserting a pre-formed glass pump-out tube 8 in an aperture/hole 10 that has previously been formed (e.g., by drilling) in one of the glass substrates 2. After the pump-out tube 8 has been seated in the aperture/hole 10, an adhesive frit paste is applied to the pump-out tube 8, typically in a region close to the opening of the hole 10 proximate an exterior surface of the glass substrate 2. As noted above, the pump-out tube may be sealed after evacuation or purging of the VIG unit cavity.

After evacuation of the cavity to a pressure less than atmospheric, sealing of the pump-out tube may be accomplished by heating an end of the pump-out tube that is used to evacuate or purge the cavity to melt the opening and thus seal the cavity of the VIG unit. For example and without limitation, this heating and melting may be accomplished by laser irradiation of the tip of the pump-out tube.

It sometimes may be the case that the pump-out tube may not be properly seated in the hole formed in the glass substrate. As a result, the pump-out tube may lean or tilt to one side, and thus not be substantially perpendicular to the surface of the glass substrate in which the hole is formed. As a result, in situations where the pump-out tube is improperly seated and is at an undesirable angle with respect to the surface of the glass substrate, it can become difficult to properly seal the pump-out tube because the laser cannot consistently melt the tip of the pump-out tube because of, for example, differences in distance between various portions of the angled pump-out tube top and the laser source. Inconsistent melting of the top of the pump-out tube may result in incomplete sealing and thus air leakage, which may, depending on the quality of the seal, occur rapidly or more slowly over time. In addition, based on the degree of tilt or tipping of the tube, the laser could hit the tube wall instead of the top. If the laser hits the tube wall, the laser could potentially bypass the tube and hit the frit, which may damage the frit or cause undesirable outgassing into the cavity.

It would seem desirable to provide a way to seat the pump-out tube in the hole to reduce the amount of tipping of the tube to be within an acceptable range. In this regard, attempts have been made to improve the evacuation and/or tip-off processes. See, for example, U.S. Pat. Nos. 9,371,683 and 8,833,105, as well as U.S. Publication No. 2013/0306222, the entire contents of each of which are hereby incorporated herein by reference. Such techniques are advantageous compared to conventional approaches. Yet the inventors of the instant application have recognized that further improvements are still possible.

For example, even when pump-out tubes are properly oriented with respect to the substrate, they still protrude outwardly from an outmost surface of the VIG unit. If the sealed tube is jostled, knocked loose, or broken in whole or in part, the VIG unit may lose vacuum faster than otherwise would be desirable. Caps sometimes are provided over protruding sealed tubes to help protect against shocks that might cause breakage and the like, but such caps have a limited effectiveness against heavy mechanical forces and add additional processing steps and materials to the VIG unit manufacturing process.

This conventional arrangement is shown more fully in FIG. 3, which is a cross-sectional schematic view of a VIG unit having a sealed pump-out tube 8 that protrudes outwardly from the VIG unit and is protected using a cap 15. When evacuating and subsequently sealing the VIG unit, the pump-out port is used to allow an evacuation path. Conventionally, this port is sealed by inserting a tube 8 with frit 9 applied thereon into a hole drilled in the glass 2, firing the frit 9 around the hole, sealing the frit 9 in place, and sealing the tube 8 by melting it with a laser, resistive filament, or similar focused energy source, thereby hermetically sealing the VIG unit. A protective cap 15 is attached to the glass surface via adhesive tape 16 or other means to help protect the delicate tube 8 that protrudes from the glass surface.

Thus, it will be appreciated that it would be desirable to completely eliminate the need for a pump-out tube that protrudes outwardly from an outmost surface of the VIG unit and/or the cap therefor.

One aspect of certain example embodiments relates to the use of a pump-out tube internal to the VIG unit. In certain example embodiments, there is no need for a pump-out tube that protrudes outwardly from an outmost surface of the VIG unit. This arrangement in certain example instances simplifies the manufacturing process, e.g., by removing the need to provide and seal a separate cap, making shipping, handling, transportation, and/or other processing operations easier because less care has to be taken by virtue of the elimination of a critical through very fragile element of the VIG unit. Frame design, lamination, IG construction, and/or the like also can be simplified.

Another aspect of certain example embodiments relates to the sealing of the internal pump-out tube such that the sealed tube does not protrude past an outermost surface of (e.g., is flush with or lies within) the VIG unit. This arrangement is advantageous in certain example instances because it can reduce and sometimes eliminate the need for a separate protruding protective cap placed above the tube. The removal of the protective cap, in turn, can be advantageous from an aesthetic perspective. Moreover, the removal of the protective cap can be advantageous in terms of reducing the likelihood of damage to the VIG unit and making shipping, handling, transportation, and/or other processing operations easier. With respect to the former, as alluded to above, bumping the cap can translate force to the sealed tube, which can cause it to move and/or break, compromising the quality of the vacuum of the VIG. With respect to the latter, because the cap is missing, it may be possible to avoid having to use special shipping and/or packaging materials that accommodate such caps.

In certain example embodiments, a method of making a vacuum insulating glass (VIG) unit is provided. First and second glass substrates are provided, with the second substrate including a hole formed therein, with the hole being formed to have first and second portions, with the first portion being closer to an outer surface of the second substrate than the second portion, with the first portion having a first width across the second substrate and the second portion having a second width across the second substrate, and with the first width being narrower than the second width, the first and second portions together forming a through-hole through the second substrate. A pump-out tube is placed in the hole. The first and second substrates are sealed together in connection with an edge seal provided around peripheral edges of the first and/or second substrates, with a cavity being defined by the first and second substrates, and with a plurality of spacers being provided between the first and second substrates in the cavity and helping to maintain the first and second substrates in substantially parallel, spaced-apart relation to one another. The cavity is evacuated to a pressure less than atmospheric. The pump-out tube is heated so as to cause a portion of tube proximate to the first substrate to collapse inwardly upon itself, covering the second width and hermetically sealing the VIG unit and forming a sealed tube, with the sealed tube being completely internal to the VIG unit.

In certain example embodiments, a method of making a vacuum insulating glass (VIG) unit subassembly is provided. A second glass substrate is provided, with the second substrate including a hole formed therein, with the hole being formed to have first and second portions, with the first portion being closer to an outer surface of the second substrate than the second portion, with the first portion having a first width across the second substrate and the second portion having a second width across the second substrate, with the first width being narrower than the second width, and with the first and second portions together forming a through-hole through the second substrate. The second substrate is forwarded to another party to: place a pump-out tube in the hole; seal together a first glass substrate with the second substrates in connection with an edge seal provided around peripheral edges of the first and/or second substrates, a cavity being defined by the first and second substrates, and a plurality of spacers being provided between the first and second substrates in the cavity and helping to maintain the first and second substrates in substantially parallel, spaced-apart relation to one another; evacuate the cavity to a pressure less than atmospheric; and laser heat the pump-out tube so as to cause a portion of tube proximate to the first substrate to collapse inwardly upon itself, covering the second width and hermetically sealing the VIG unit and forming a sealed tube, the sealed tube being completely internal to the VIG unit.

In certain example embodiments, there is provided a vacuum insulating glass (VIG) unit, comprising: first and second glass substrates maintained in substantially parallel, spaced apart relation to one another via a hermetic edge seal and a plurality of spacers disposed in a cavity defined between the first and second glass substrates, the cavity being evacuated to a pressure less than atmospheric using a pump-out port hermetically sealed with a laser-sealed tube laser, the laser-sealed tube including a sealing portion made therefrom proximate to the cavity, the laser-sealed tube being located internal to the VIG unit and without protruding thereform.

In certain example embodiments, a method of making a vacuum insulating glass (VIG) unit is provided. The method comprises having first and second glass substrates, the second substrate including a through-hole formed therein. A cover is placed on the second glass substrate over the hole. The first and second substrates are sealed together in connection with an edge seal provided around peripheral edges of the first and/or second substrates, a cavity being defined by the first and second substrates, and a plurality of spacers being provided between the first and second substrates in the cavity and helping to maintain the first and second substrates in substantially parallel, spaced-apart relation to one another, the cover being provided between the first and second substrates. The cavity is evacuated to a pressure less than atmospheric. Following the evacuating, the cover is connected to an inner surface of the second substrate and hermetically seal the VIG unit, the cover being completely internal to the VIG unit.

In certain example embodiments, there is provided a vacuum insulating glass (VIG) unit, comprising: first and second glass substrates maintained in substantially parallel, spaced apart relation to one another via a hermetic edge seal and a plurality of spacers disposed in a cavity defined between the first and second glass substrates, the cavity being evacuated to a pressure less than atmospheric using a pump-out port hermetically sealed with a cover, the cover being provided in the cavity without protruding from the VIG unit.

The features, aspects, advantages, and example embodiments described herein may be combined to realize yet further embodiments.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a cross-sectional schematic diagram of a conventional vacuum insulated glass (VIG) unit;

FIG. 2 is a top plan view of a conventional VIG unit;

FIG. 3 is a cross-sectional schematic view of a VIG unit having a sealed pump-out tube that protrudes outwardly from the VIG unit and is protected using a cap;

FIG. 4 is a cross-sectional schematic view demonstrating how a first example internal pump-out tube can be sealed, in accordance with certain example embodiments;

FIG. 5 is a cross-sectional schematic view showing the first example internal pump-out tube of FIG. 4 sealed in accordance with certain example embodiments;

FIG. 6 is a cross-sectional schematic view demonstrating how a second example internal pump-out tube can be sealed, in accordance with certain example embodiments;

FIG. 7 is a cross-sectional schematic view showing the second example internal pump-out tube of FIG. 6 sealed in accordance with certain example embodiments;

FIG. 8 is a flowchart showing an example process for making a VIG unit in connection with an internal pump-out tube, in accordance with certain example embodiments;

FIG. 9 is a cross-sectional schematic view demonstrating another approach to sealing a pump-out port, in accordance with certain example embodiments; and

FIG. 10 is a flowchart showing another example process for making a VIG unit in connection with an internal seal, in accordance with certain example embodiments.

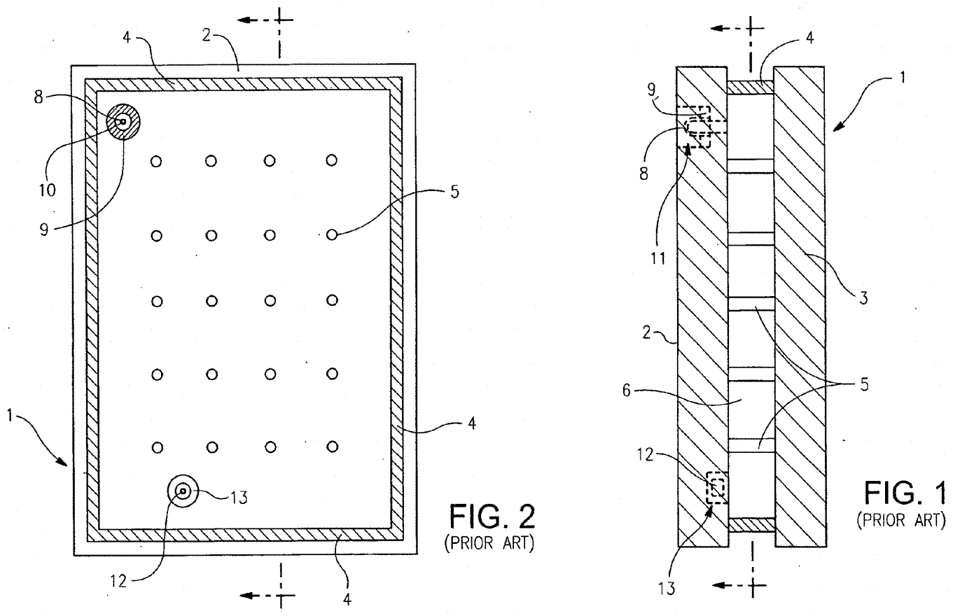

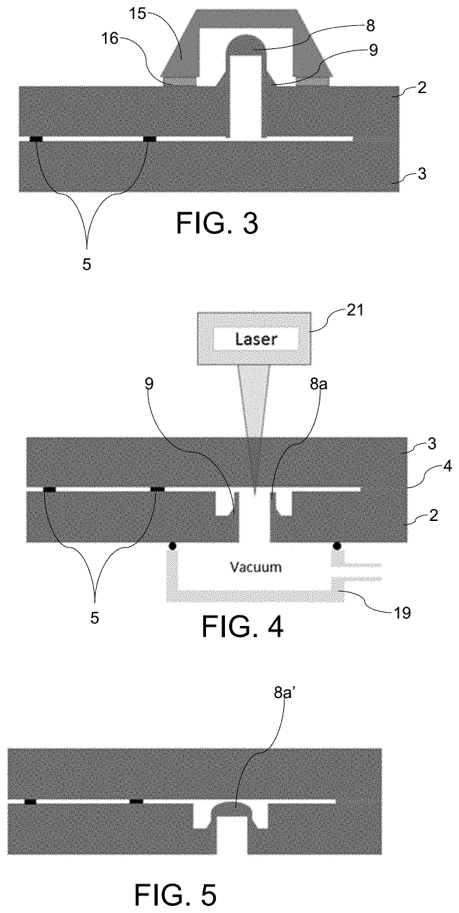

### DETAILED DESCRIPTION

Certain example embodiments relate to improved techniques for evacuating vacuum insulated glass (VIG) units. More particularly, certain example embodiments of this invention relate to an internal pump-out tube for VIG unit evacuation and hermetic sealing, a VIG unit subassembly including an internal pump-out tube, a VIG unit made using an internal pump-out tube, and/or associated methods. Typically, the internal space of a VIG unit is evacuated through a surface mounted tube or other structure that facilitates sealing once the internal space reaches sufficiently low pressures. That tube or other structure protrudes from the surface even when sealed and typically is protected with a protective cap but nonetheless oftentimes requires special handling. Certain example embodiments improve upon this approach by relocating the sealing tube to within the VIG unit, thereby potentially eliminating the need for a protective cap and allowing for more freedom in handling, frame design, hybrid VIG construction, lamination, and the like. In essence, the sealing tube is relocated to an internal surface within a recessed pocket, at least in certain example embodiments.

In certain example embodiments, the sealed internal tube is flush with, or recessed with respect to, the outer surface of the glass of the VIG. As a result, a protective cap need not be applied thereover. This in turn can lead to easier processing, especially for secondary processes such as lamination, hybrid VIG manufacturing, etc. Additionally, the elimination of an external tube that protrudes outwardly from the substrate may allow for improvements to be realized in shipping approaches, e.g., as additional packing dunnage to properly space apart the VIG units to account for the extra protrusion need not be provided. Standard, or more standard, packaging and the like may be used in certain example embodiments.

There are multiple internal tube designs that may be used in connection with different example embodiments. In this regard, FIG. 4 is a cross-sectional schematic view demonstrating how a first example internal pump-out tube 8a can be sealed in accordance with certain example embodiments, and FIG. 5 is a cross-sectional schematic view showing the first example internal pump-out tube 8a of FIG. 4 sealed in accordance with certain example embodiments.

The tube 8a is internal to the VIG unit subassembly of FIG. 4 and in essence sits in a pocket drilled in the substrate 3. The tube 8a may be held in place using frit 9 that may be fired as per conventional approaches. However, the tube 8a itself does not protrude beyond the outer surface of the substrate 3. There is little space between the substrates 2,3, as the cavity defined therebetween is quite narrow. However, the pocket in which the tube 8a sits is advantageous because it allows more tube material to be exposed and used in forming the seal, as will be appreciated from the description below. The port in which the tube 8a is to sit may be formed by drilling a through-hole of a first diameter or major distance, and the pocket may be formed by drilling a recess in the substrate proximate to the through-hole. This recess is not a through-hole, otherwise it merely would serve as a larger (or supplementary) pump-out port. The through-hole and the recess used to form the pocket may be formed in registration with one another, e.g., so that the approximate centers of each are substantially aligned (e.g., from plan view and/or cross-sectional perspectives, the latter of which can be appreciated from FIG. 4). The through-hole and the recess used to form the pocket may be substantially circular in plan view in certain example embodiments, although other configurations are possible in different example embodiments.

The VIG unit subassembly shown in FIG. 4 is evacuated through the tube 8a, which open to the interior air space or cavity, using a vacuum 19. A vacuum cup is shown in the FIG. 4 example, but it need not be used in all embodiments (e.g., in embodiments where the entire subassembly is processed in vacuum conditions). When sufficiently low pressure is reached, a laser 21 is used to seal the tube 8a. The laser 21 may be directed through the other glass substrate 2, so as to heat the tube 8a at its side proximate to the cavity and promote sagging of the melted tube material until it eventually covers over the hole. This will cause the side wall of the tube 8a to begin to sag inwardly. The laser 21 may trace the sag as a bridge begins to form, hermetically sealing the tube 8a. The sealed tube 8a′ is shown in FIG. 5.

The glass substrate 2 preferably is sufficiently transparent to the wavelength of the laser 21 so as avoid absorbing a significant amount of energy before it reaches the tube 8a. The tube 8a, by contrast, preferably is sufficiently opaque to that wavelength to absorb the energy and form the seal. In this sense, the tube 8a may be heated preferentially (e.g., compared to the substrate 2 and/or the substrate 3).

Additionally, in certain example embodiments, the heating may be preferential heating that includes a first or core heating phase to substantially melt the tube (or sealing sidewall(s)), followed by a second phase that causes tube (or sealing sidewall(s)) to sag together and form the bridge. One or both of these phases may preferentially heat the tube (or sealing sidewall(s)) relative to the rest of the VIG unit subassembly including, for example, the overlying substrate. Laser heating may be used for either or both phases in different example embodiments. Although laser heating is mentioned herein, it will be appreciated that infrared (IR) heating may be used in connection with any heating procedure described herein.

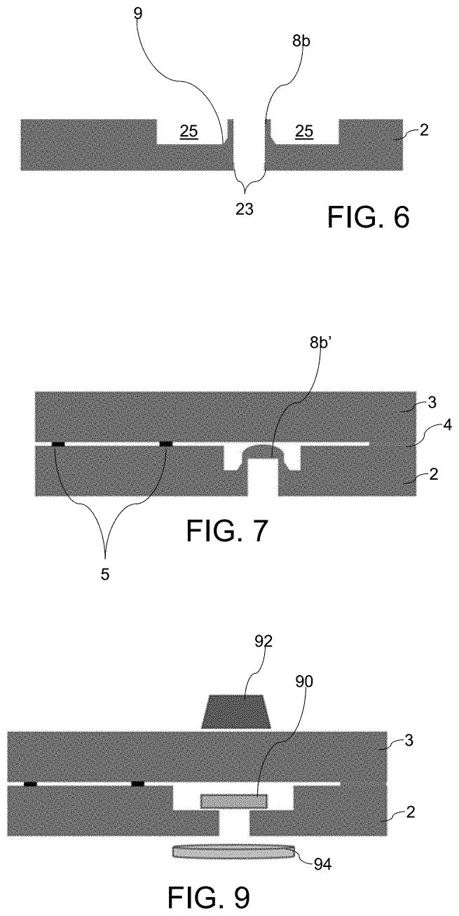

FIG. 6 is a cross-sectional schematic view demonstrating how a second example internal pump-out tube can be sealed in accordance with certain example embodiments, and FIG. 7 is a cross-sectional schematic view showing the second example internal pump-out tube of FIG. 6 sealed in accordance with certain example embodiments. FIGS. 6-7 are similar to FIGS. 4-5.

However, FIGS. 6-7 show a pump-out tube 8b inserted into a hole that includes one or more steps 23. The presence of one or more steps 23 may be advantageous in terms of helping to reduce the likelihood of the tube 8b from falling through the glass substrate 3, e.g., during processing operations (including during evacuation). The step(s) 23 also further helps reduce the likelihood of the tube slipping to a position at which it might protrude from the outer surface of the substrate 3, e.g., as shown with the sealed tube 8b′ in FIG. 7. Frit may be applied in on step portions, as well. The step(s) 23 may be formed via any suitable technique such as, for example, drilling. Registration with the through-hole and the recess, configuration options, etc., as noted above may be applied with respect to the step portion(s) as well.

The machined pocket in certain example embodiments can be expanded to allow for insertion of a getter around the sealing tube. The expansion areas 25 are shown in FIG. 6, but this approach can be used in connection with other example embodiments (including the FIG. 4 example embodiment).

In certain example embodiments, the tube and sealing frit can be installed pre-tempering for construction of tempered VIG units. The sealing frit may be fired during the tempering process, which may allow for higher melting point frits to be used in obtaining a hermetic seal.

In certain example embodiments, the pump-out tube may be integral or integrated with the substrate. For example, a profile/cross-section may be formed by creating a through-hole, and a channel or groove around the through-hole. The glass that is left between the through-hole and the channel forms one or more side walls for the through-hole and/or sealing arms for the VIG unit itself. These features may be formed in any suitable manner such as, for example, by drilling into a substrate. The internal, integrated pump-out tube in this sense is at least partially defined by the through-hole and the groove, channel, or recess formed around the through-hole. Ultimately, the sealing arm(s) may be melted to collapse over the through-hole and form a “plugless” bridge that hermetically seals the VIG unit, similar to as if a separate tube were provided.

When viewed in cross-section, the recess(es) may be generally U-shaped, semi-circular, trapezoidal, and/or the like. Successive drilling operations may be performed to approximate these and/or other shapes, as well, e.g., in a more stepped manner.

When viewed in plan view, generally circular, ovular, square, rectangular, and/or other features may be used for the through-hole and/or recess in different example embodiments. For instance, generally square-shaped, ovular, and/or other configurations, when viewed from a plan view, may be used in different example embodiments. It also will be appreciated that differently shaped features may be used in connection with a single embodiment. For instance, when viewed from a plan view, an example embodiment may include a generally circular through-hole and a groove, channel, or recess that at its outer extent is generally square shaped, rectangular, etc. Similarly, when viewed from a plan view, an example embodiment may include a generally rectangular or square-shaped through-hole and a groove, channel, or recess that at its outer extent is generally circular, ovular, etc.

It will be appreciated that a recess need not extend entirely around the through-hole in all embodiments. Instead, multiple collapsible arms may be created, e.g., via multiple recesses. These multiple recesses may take different sizes and/or shapes, similar to as described in the previous paragraph.

The techniques of U.S. Pat. No. 9,371,683 (the entire contents of which are hereby incorporated herein by reference) may be used to seal the internal tube, e.g., by tracing smaller and smaller circles or other connected patterns around the tube proximate to the sidewall(s)/sealing arm(s) so as to cause opposing edges of the sidewall(s)/sealing arm(s) to sag towards one another and form a bridge (e.g., as shown in FIG. 5 and FIG. 7). In cases where multiple separate sidewalls/sealing arms are provided, progressive scans of narrower width may be used to similar effect. For instance, one or more lasers may be used to scan along first and second upwardly projecting sealing arms to cause them to sag towards one another. The laser(s) may be focused along scan lines or scan areas that are increasingly close to one another, e.g., as the sag continues to develop in the formation of the bridge.

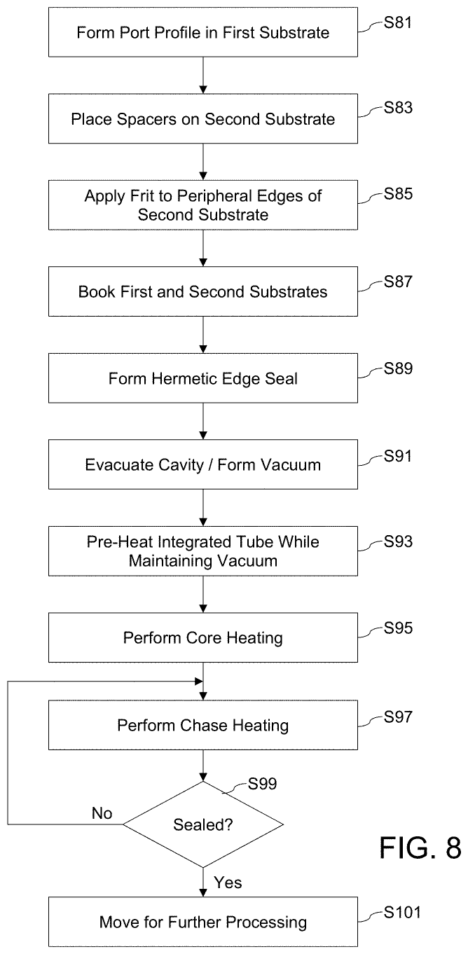

FIG. 8 is a flowchart showing an example process for making a VIG unit in connection with an internal pump-out tube, in accordance with certain example embodiments. In step S81, the internal port profile is formed in the first substrate, e.g., via one or more drilling operations or the like. Spacers or pillars are placed on the second substrate in step S83. In step S85, frit material is applied to peripheral edges of the second substrate. The first and second substrates are booked together in step S87 so that a cavity is formed therebetween, and a hermetic edge seal is formed in step S89 (e.g., via laser heating, heating in an oven, using infrared heaters, and/or the like). The cavity is evacuated to a pressure less than atmospheric in step S91. The internal tube optionally is pre-heated in step S93, e.g., while maintaining the vacuum. This may be accomplished using an oven, using infrared heaters, via a laser, etc. Core heating is performed in step S95, and chase heating is performed in step S97 repeatedly until the tube is sealed (e.g., as indicated in step S99). The core heating process of step S95 provides the bulk of the melting process, whereas the chase heating of step S97 is provided at progressively smaller circumferences, areas, and/or the like, e.g., depending on the configuration of the tube, sidewall(s)/sealing arm(s), the through-hole, the developing sag, etc. Once sealed, the unit may be moved for further processing in step S101.

As will be appreciated from the above, internal sealing is not limited to the use of a separate glass tube. As noted, an integrated tube, formed from one of the substrates itself, can be used in certain example embodiments. Moreover, certain example embodiments may make use of a hermetic sealing material (e.g., a metal solder) that can withstand the VIG processing temperatures and can be placed into a VIG subassembly to help seal the pump-out port from within. FIG. 9, for example, is a cross-sectional schematic view demonstrating another approach to sealing a pump-out port, in accordance with certain example embodiments. As shown in FIG. 9, a metallic or other disc 90 is provided in the cavity. The disc 90 has solder provided on a surface thereof that is intended to mate with the pocket formed in the substrate 3. The solder may be sufficiently shaped to allow gasses to evacuate through the port in certain example embodiments. In addition, or in the alternative, in certain example embodiments, the disc 90 may be held “above” the pump port via one or more magnets 92 during pump down, thereby permitting the egress of air and/or contaminant materials. The disc 90 and/or solder applied thereto may be heated via induction (e.g., using induction coil 94), laser, or other means, e.g., to seal the pump-out port from within.

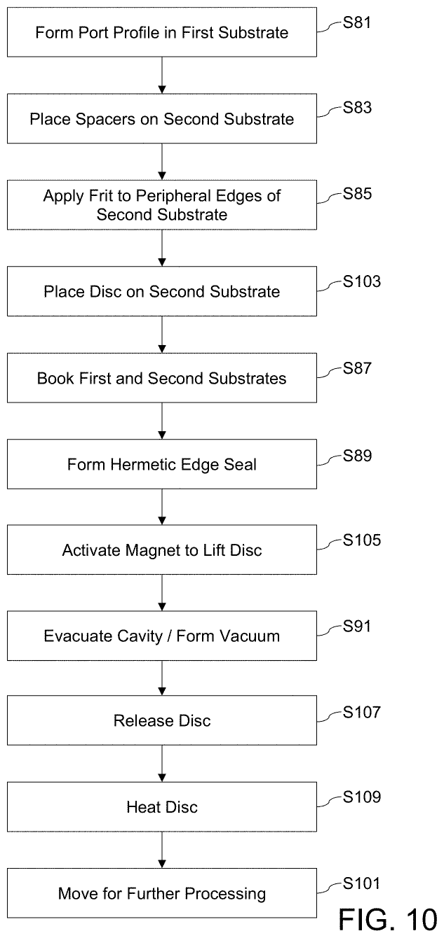

FIG. 10 is a flowchart showing another example process for making a VIG unit in connection with an internal seal, in accordance with certain example embodiments. FIG. 10 is similar to FIG. 8 in many respects. For example, in step S81, the internal pump-out port profile is formed in the first substrate, e.g., via one or more drilling operations or the like. Spacers or pillars are placed on the second substrate in step S83. In step S85, frit material is applied to peripheral edges of the second substrate. However, unlike in FIG. 8, a disc is placed onto the second substrate (e.g., proximate to the formed port) in step S103. The disc may have frit or other sealing material applied to it prior to being placed on the second substrate. Once again, similar to FIG. 8, the first and second substrates are booked together in step S87 so that a cavity is formed therebetween (e.g., with the disc in the cavity), and a hermetic edge seal is formed in step S89 (e.g., via laser heating, heating in an oven, using infrared heaters, and/or the like). The magnet is activated to lift the disc in step S105. The cavity is evacuated to a pressure less than atmospheric in step S91. The disc is released in step S107, and it is heated in step S109. Once sealed, the unit may be moved for further processing in step S101.

It will be appreciated that the steps in the FIG. 8 and FIG. 10 example processes may be performed in any suitable order, by different parties, and/or that further steps may be provided in different example embodiments. For instance, different parties may form the hole compared to parties who seal the VIG and/or port. In certain example embodiments, a tube profile will be formed in the first substrate, the first and/or second substrate may be tempered, frit may be applied to the peripheral edges of the first and/or second substrate, spacers may be placed, and then other operations may be performed, e.g., as shown in these drawings.

In certain example embodiments, where a separate tube is provided, the through-hole may be 0.5-5 mm in diameter or major distance, more preferably 1-3 mm in diameter or major distance, and still more preferably 1.5-2.6 mm in diameter or major distance. In certain example embodiments, where an integral or integrated tube is provided, the through-hole may be 0.5-5 mm in diameter or major distance, more preferably 1.5-4 mm in diameter or major distance, and still more preferably 2-3.5 mm in diameter or major distance. In example embodiments that use tubes, the tubes may be slightly smaller in width or major distance (e.g., 0.1-1 mm smaller in width or major distance). In certain example embodiments, the tube sidewall thickness may be 0.2-0.5 mm thick, more preferably 0.25-0.45 mm thick.

Any suitable laser may be used for sealing. For example, a 1064 nm wavelength laser operating at 10-30 watts, more preferably 20-30 watts may be used. With such lasers and diameters, it has been found that tubes may be sealed by firing through float glass and that about 10-30% more energy is required compared to sealing the tubes unobstructed. The increase may be provided in time and/or power in different example embodiments.

In certain example embodiments where a sealing disc or the like is used, the through-hole would preferably is 4-5 mm in diameter or major distance. The disc preferably is about twice the size of the hole. For instance, in certain example embodiments, the disc may be about 7-10 mm in diameter or major distance. It may be made of a ferromagnetic material that would have a solder or metallic layer that could be fused to the interior surface upon heating in certain example embodiments.

It will be appreciated that techniques disclosed herein may be used in a wide variety of applications including for example, in VIG window applications, merchandizers, laminated products, hybrid VIG units (e.g., units where a substrate is spaced apart from a VIG unit via a spacer system), etc.

The terms “heat treatment” and “heat treating” as used herein mean heating the article to a temperature sufficient to achieve thermal tempering and/or heat strengthening of the glass inclusive article. This definition includes, for example, heating a coated article in an oven or furnace at a temperature of at least about 550 degrees C., more preferably at least about 580 degrees C., more preferably at least about 600 degrees C., more preferably at least about 620 degrees C., and most preferably at least about 650 degrees C. for a sufficient period to allow tempering and/or heat strengthening. This may be for at least about two minutes, or up to about 10 minutes, in certain example embodiments. These processes may be adapted to involve different times and/or temperatures.

As used herein, the terms “on,” “supported by,” and the like should not be interpreted to mean that two elements are directly adjacent to one another unless explicitly stated. In other words, a first layer may be said to be “on” or “supported by” a second layer, even if there are one or more layers therebetween.

In certain example embodiments, a method of making a vacuum insulating glass (VIG) unit is provided. First and second glass substrates are provided, with the second substrate including a hole formed therein, with the hole being formed to have first and second portions, with the first portion being closer to an outer surface of the second substrate than the second portion, with the first portion having a first width across the second substrate and the second portion having a second width across the second substrate, and with the first width being narrower than the second width, the first and second portions together forming a through-hole through the second substrate. A pump-out tube is placed in the hole. The first and second substrates are sealed together in connection with an edge seal provided around peripheral edges of the first and/or second substrates, with a cavity being defined by the first and second substrates, and with a plurality of spacers being provided between the first and second substrates in the cavity and helping to maintain the first and second substrates in substantially parallel, spaced-apart relation to one another. The cavity is evacuated to a pressure less than atmospheric. The pump-out tube is heated so as to cause a portion of tube proximate to the first substrate to collapse inwardly upon itself, covering the second width and hermetically sealing the VIG unit and forming a sealed tube, with the sealed tube being completely internal to the VIG unit.

In addition to the features of the previous paragraph, in certain example embodiments, the first and second portions of the hole may be formed by drilling.

In addition to the features of either of the two previous paragraphs, in certain example embodiments, the pump-out tube may be sealed to the second substrate using frit material provided to the pump-out tube and/or the second substrate.

In addition to the features of any of the three previous paragraphs, in certain example embodiments, the hole may comprise a step portion formed in the first portion, e.g., with the step portion being sized, shaped, and arranged to support the pump-out tube during the sealing together of the first and second substrates through heating of the pump-out tube.

In addition to the features of any of the four previous paragraphs, in certain example embodiments, the second portion may form at least a part of a pocket in the second substrate. For instance, getter material may be provided to the pocket.

In addition to the features of any of the five previous paragraphs, in certain example embodiments, the heating may be laser heating.

In addition to the features of the previous paragraph, in certain example embodiments, the laser heating may be practiced so as to preferentially heat the pump-out tube relative to the first substrate.

In addition to the features of either of the two previous paragraphs, in certain example embodiments, the heating may be performed in connection with a laser placed on a side of the first substrate opposite the second substrate such that the laser emits energy through the first substrate.

In addition to the features of any of the three previous paragraphs, in certain example embodiments, the laser heating may include tracing collapsing portions of the tube as the tube collapses inwardly upon itself in forming the sealed tube.

In certain example embodiments, a method of making a vacuum insulating glass (VIG) unit subassembly is provided. A second glass substrate is provided, with the second substrate including a hole formed therein, with the hole being formed to have first and second portions, with the first portion being closer to an outer surface of the second substrate than the second portion, with the first portion having a first width across the second substrate and the second portion having a second width across the second substrate, with the first width being narrower than the second width, and with the first and second portions together forming a through-hole through the second substrate. The second substrate is forwarded to another party to: place a pump-out tube in the hole; seal together a first glass substrate with the second substrates in connection with an edge seal provided around peripheral edges of the first and/or second substrates, a cavity being defined by the first and second substrates, and a plurality of spacers being provided between the first and second substrates in the cavity and helping to maintain the first and second substrates in substantially parallel, spaced-apart relation to one another; evacuate the cavity to a pressure less than atmospheric; and laser heat the pump-out tube so as to cause a portion of tube proximate to the first substrate to collapse inwardly upon itself, covering the second width and hermetically sealing the VIG unit and forming a sealed tube, the sealed tube being completely internal to the VIG unit.

In addition to the features of the previous paragraph, in certain example embodiments, the first and second portions of the hole may be formed by drilling.

In addition to the features of either of the two previous paragraphs, in certain example embodiments, the second portion may form at least a part of a pocket in the second substrate.

In addition to the features of any of the three previous paragraphs, in certain example embodiments, the laser heating may be practiced so as to preferentially heat the pump-out tube relative to the first substrate.

In addition to the features of any of the four previous paragraphs, in certain example embodiments, the laser heating may be performed in connection with a laser placed on a side of the first substrate opposite the second substrate such that the laser emits energy through the first substrate.

Certain example embodiments relate to a vacuum insulating glass (VIG) unit made by the method of any one of the 14 preceding paragraphs.

In certain example embodiments, there is provided a vacuum insulating glass (VIG) unit, comprising: first and second glass substrates maintained in substantially parallel, spaced apart relation to one another via a hermetic edge seal and a plurality of spacers disposed in a cavity defined between the first and second glass substrates, the cavity being evacuated to a pressure less than atmospheric using a pump-out port hermetically sealed with a laser-sealed tube laser, the laser-sealed tube including a sealing portion made therefrom proximate to the cavity, the laser-sealed tube being located internal to the VIG unit and without protruding thereform.

In addition to the features of the previous paragraph, in certain example embodiments, the tube may be connected to the second substrate of the VIG unit via frit material.

In addition to the features of either of the two previous paragraphs, in certain example embodiments, getter may be provided on opposing sides of the laser-sealed tube in a pocket formed in the second substrate.

In addition to the features of any of the three previous paragraphs, in certain example embodiments, the tube may be located on a stepped portion of the pump-out port.

In certain example embodiments, a method of making a vacuum insulating glass (VIG) unit is provided. The method comprises having first and second glass substrates, the second substrate including a through-hole formed therein. A cover is placed on the second glass substrate over the hole. The first and second substrates are sealed together in connection with an edge seal provided around peripheral edges of the first and/or second substrates, a cavity being defined by the first and second substrates, and a plurality of spacers being provided between the first and second substrates in the cavity and helping to maintain the first and second substrates in substantially parallel, spaced-apart relation to one another, the cover being provided between the first and second substrates. The cavity is evacuated to a pressure less than atmospheric. Following the evacuating, the cover is connected to an inner surface of the second substrate and hermetically seal the VIG unit, the cover being completely internal to the VIG unit.

In addition to the features of the previous paragraph, in certain example embodiments, the cover may be sealed to the second substrate using frit material provided to the cover and/or the second substrate.

In addition to the features of either of the two previous paragraphs, in certain example embodiments, the cover may be magnetic and the method may further comprises lifting the cover during the evacuating, using a magnet; and allowing the cover to rest on the second substrate following the evacuating in preparation for sealing the cover to the second substrate.

In addition to the features of any of the three previous paragraphs, in certain example embodiments, a pocket may be provided in the second substrate about the through-hole and on a side of the second substrate facing the first substrate, e.g., with the pocket having getter provided thereto.

In addition to the features of any of the four previous paragraphs, in certain example embodiments, the connecting may be practiced in connection with an induction coil. For instance, the induction coil may be provided on a side of the second substrate opposite the first substrate.

In addition to the features of any of the five previous paragraphs, in certain example embodiments, the connecting may be practiced by heating the cover and/or an area proximate thereto.

In addition to the features of the previous paragraph, in certain example embodiments, the heating may be laser heating.

In addition to the features of the previous paragraph, in certain example embodiments, the laser heating may be practiced so as to preferentially heat the cover and/or frit material applied thereto, relative to the first substrate.

In addition to the features of any of the three previous paragraphs, in certain example embodiments, the heating may be performed in connection with a laser placed on a side of the first substrate opposite the second substrate such that the laser emits energy through the first substrate.

Certain example embodiments relate to a vacuum insulating glass (VIG) unit made by the method of any one of the nine preceding paragraphs.

In certain example embodiments, there is provided a vacuum insulating glass (VIG) unit, comprising: first and second glass substrates maintained in substantially parallel, spaced apart relation to one another via a hermetic edge seal and a plurality of spacers disposed in a cavity defined between the first and second glass substrates, the cavity being evacuated to a pressure less than atmospheric using a pump-out port hermetically sealed with a cover, the cover being provided in the cavity without protruding from the VIG unit.

In addition to the features of the previous paragraph, in certain example embodiments, the cover may be connected to the second substrate of the VIG unit via frit material.

In addition to the features of either of the two previous paragraphs, in certain example embodiments, getter may be provided on opposing sides of port in a pocket formed in the second substrate.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of making a vacuum insulating glass (VIG) unit, the method comprising:
providing first and second glass substrates, the second substrate including a hole formed therein, the hole being formed to have first and second portions, the first portion being closer to an outer surface of the second substrate than the second portion, the first portion having a first width across the second substrate and the second portion having a second width across the second substrate, the first width being narrower than the second width, the first and second portions together forming a through-hole through the second substrate;
placing a pump-out tube in the hole;
sealing together the first and second substrates in connection with an edge seal provided around peripheral edges of the first and/or second substrates, a cavity being defined by the first and second substrates, and a plurality of spacers being provided between the first and second substrates in the cavity and helping to maintain the first and second substrates in substantially parallel, spaced-apart relation to one another;
evacuating the cavity to a pressure less than atmospheric; and
heating the pump-out tube so as to cause a portion of tube proximate to the first substrate to collapse inwardly upon itself, covering the second width and hermetically sealing the VIG unit and forming a sealed tube, the sealed tube being completely internal to the VIG unit.

2. The method of claim 1, wherein the first and second portions of the hole are formed by drilling.

3. The method of claim 1, further comprising sealing the pump-out tube to the second substrate using frit material provided to the pump-out tube and/or the second substrate.

4. The method of claim 1, wherein the hole comprises a step portion formed in the first portion, the step portion being sized, shaped, and arranged to support the pump-out tube during the sealing together of the first and second substrates through heating of the pump-out tube.

5. The method of claim 1, wherein the second portion forms at least a part of a pocket in the second substrate.

6. The method of claim 5, further comprising providing getter material to the pocket.

7. The method of claim 1, wherein the heating is laser heating.

8. The method of claim 7, wherein the laser heating is practiced so as to preferentially heat the pump-out tube relative to the first substrate.

9. The method of claim 7, wherein the heating is performed in connection with a laser placed on a side of the first substrate opposite the second substrate such that the laser emits energy through the first substrate.

10. The method of claim 7, wherein the laser heating includes tracing collapsing portions of the tube as the tube collapses inwardly upon itself in forming the sealed tube.

11. A method of making a vacuum insulating glass (VIG) unit subassembly, the method comprising:
providing a second glass substrate, the second substrate including a hole formed therein, the hole being formed to have first and second portions, the first portion being closer to an outer surface of the second substrate than the second portion, the first portion having a first width across the second substrate and the second portion having a second width across the second substrate, the first width being narrower than the second width, the first and second portions together forming a through-hole through the second substrate; and
forwarding the second substrate to another party to:
place a pump-out tube in the hole;
seal together a first glass substrate with the second substrates in connection with an edge seal provided around peripheral edges of the first and/or second substrates, a cavity being defined by the first and second substrates, and a plurality of spacers being provided between the first and second substrates in the cavity and helping to maintain the first and second substrates in substantially parallel, spaced-apart relation to one another;
evacuate the cavity to a pressure less than atmospheric; and
laser heat the pump-out tube so as to cause a portion of tube proximate to the first substrate to collapse inwardly upon itself, covering the second width and hermetically sealing the VIG unit and forming a sealed tube, the sealed tube being completely internal to the VIG unit.

12. The method of claim 11, wherein the first and second portions of the hole are formed by drilling.

13. The method of claim 11, wherein the second portion forms at least a part of a pocket in the second substrate.

14. The method of claim 11, wherein the laser heating is practiced so as to preferentially heat the pump-out tube relative to the first substrate.

15. The method of claim 11, wherein the laser heating is performed in connection with a laser placed on a side of the first substrate opposite the second substrate such that the laser emits energy through the first substrate.

16. A vacuum insulating glass (VIG) unit, comprising:
first and second glass substrates maintained in substantially parallel, spaced apart relation to one another via a hermetic edge seal and a plurality of spacers disposed in a cavity defined between the first and second glass substrates, the cavity being evacuated to a pressure less than atmospheric using a pump-out port hermetically sealed with a laser-sealed tube laser, the laser-sealed tube including a sealing portion made therefrom proximate to the cavity, the laser-sealed tube being located internal to the VIG unit and without protruding thereform.

17. The VIG unit of claim 16, wherein the tube is connected to the second substrate of the VIG unit via frit material.

18. The VIG unit of claim 17, further comprising getter provided on opposing sides of the laser-sealed tube in a pocket formed in the second substrate.

19. The VIG unit of claim 16, wherein the tube is located on a stepped portion of the pump-out port.

20. A vacuum insulating glass (VIG) unit made by the method of claim 1.

21. A method of making a vacuum insulating glass (VIG) unit, the method comprising:
having first and second glass substrates, the second substrate including a through-hole formed therein;
placing a cover on the second glass substrate over the hole;
sealing together the first and second substrates in connection with an edge seal provided around peripheral edges of the first and/or second substrates, a cavity being defined by the first and second substrates, and a plurality of spacers being provided between the first and second substrates in the cavity and helping to maintain the first and second substrates in substantially parallel, spaced-apart relation to one another, the cover being provided between the first and second substrates;
evacuating the cavity to a pressure less than atmospheric; and
following the evacuating, connecting the cover to an inner surface of the second substrate and hermetically seal the VIG unit, the cover being completely internal to the VIG unit.

22. The method of claim 21, further comprising sealing the cover to the second substrate using frit material provided to the cover and/or the second substrate.

23. The method of claim 21, wherein the cover is magnetic and further comprising:
lifting the cover during the evacuating, using a magnet; and
allowing the cover to rest on the second substrate following the evacuating in preparation for sealing the cover to the second substrate.

24. The method of claim 21, wherein a pocket is provided in the second substrate about the through-hole and on a side of the second substrate facing the first substrate, the pocket having getter provided thereto.

25. The method of claim 21, wherein the connecting is practiced in connection with an induction coil.

26. The method of claim 25, wherein the induction coil is provided on a side of the second substrate opposite the first substrate.

27. The method of claim 21, wherein the connecting is practiced by heating the cover and/or an area proximate thereto.

28. The method of claim 27, wherein the heating is laser heating.

29. The method of claim 28, wherein the laser heating is practiced so as to preferentially heat the cover and/or frit material applied thereto, relative to the first substrate.

30. The method of claim 27, wherein the heating is performed in connection with a laser placed on a side of the first substrate opposite the second substrate such that the laser emits energy through the first substrate.

31. A vacuum insulating glass (VIG) unit, comprising:
first and second glass substrates maintained in substantially parallel, spaced apart relation to one another via a hermetic edge seal and a plurality of spacers disposed in a cavity defined between the first and second glass substrates, the cavity being evacuated to a pressure less than atmospheric using a pump-out port hermetically sealed with a cover, the cover being provided in the cavity without protruding from the VIG unit.

32. The VIG unit of claim 31, wherein the cover is connected to the second substrate of the VIG unit via frit material.

33. The VIG unit of claim 31, further comprising getter provided on opposing sides of port in a pocket formed in the second substrate.

34. A vacuum insulating glass (VIG) unit made by the method of claim 21.
